(19) United States
(12) Patent Application Publication
(10) Pub. No.: US 2014/0014037 A1
(43) Pub. Date: Jan. 16, 2014

(54) ELECTRODE PLATE PRODUCTION DEVICE

(71) Applicants: Atsushi Watanabe, Nagaizumi-cho (JP); Kazuhiko Fujita, Kusatsu-city (JP)

(72) Inventors: Atsushi Watanabe, Nagaizumi-cho (JP); Kazuhiko Fujita, Kusatsu-city (JP)

(21) Appl. No.: 14/007,134

(22) PCT Filed: Mar. 13, 2012
(86) PCT No.: PCT/JP2012/056335

§ 371 Date: Sep. 24, 2013

(30) Foreign Application Priority Data
Mar. 29, 2011 (JP) 2011-072779

(51) Int. Cl. H01M 4/04

(52) U.S. Cl. CPC H01M 4/0404
USPC 118/713; 118/68

(57) ABSTRACT

An electrode plate production device includes a drying device and a plurality of surface state detection devices. The drying device is configured to dry a coating film for forming an active material layer that is coated on a surface of a substrate sheet for forming a current collector while the substrate sheet travels in a traveling direction. The coating film includes at least an active material, a bonding agent and a solvent. The surface state detection devices are configured to detect a surface state of the coating film in a noncontact manner. The surface state detection devices are arranged within the drying device in the traveling direction of the substrate sheet with respect to each other.

### CROSS-REFERENCE TO RELATED APPLICATIONS

This application is a U.S. National stage of International Application No. PCT/JP2012/056335 filed on Mar. 13, 2012. This application claims priority to Japanese Patent Application No. 2011-072779 filed with Japan Patent Office on Mar. 29, 2011. The entire disclosure of Japanese Patent Application No. 2011-072779 is hereby incorporated herein by reference.

### BACKGROUND

1. Field of the Invention

The present invention relates to a production device of an electrode plate including a substrate sheet for forming a current collector and an active material layer formed on the substrate sheet, and more specifically to a production device of an electrode plate equipped with a drying device configured to dry a coating film of the active material layer coated on the substrate sheet in a desired progress state.

2. Background Information

In lithium-ion cells or fuel cells, generally, a structure is employed in which a plurality of electrode plates each made of a substrate sheet for forming a current collector and having an active material layer of a predetermined shape on a surface are laminated. In producing such an electrode plate, normally, while traveling a substrate sheet relatively unstable in dimension, a coating film for forming an active material layer containing at least an active material, a bonding agent and a solvent is applied on the surface of the substrate sheet, and the applied coating film is dried in a drying device to be firmly fixed to the substrate sheet. In drying this coating film, it is generally known that there exists an optimum drying progress property (see Japanese Patent No. 4571841 (Patent Document 1), for example). When the drying condition largely deviates from the optimum drying progress property, there arise problems that the peel strength of the coating film from the substrate sheet after drying in which the solvent was evaporated deteriorates, or the bonding agents are unevenly distributed in the coating film after drying in the thickness direction of the coating film (especially the bonding agents are deposited on the outer surface side of the coating film), making it difficult to obtain a target electrode property, which in turn makes it difficult to obtain a target battery property.

To dry the coating film, it is possible to use a heater such as an infrared heater. However, in many cases, the drying is performed by hot-air drying in which hot-air heated to a predetermined temperature is blown out through a nozzle. In such cases, the length of the hot-air oven of the drying device sometimes reaches 20 to 50 m. In such a drying device long in the traveling direction of the substrate sheet, in order to realize the optimum drying progress property mentioned above, as described in, for example, Patent Document 1, it is desired that the hot-air oven is partitioned into several zones in the traveling direction of the sheet and the atmosphere temperature of each zone and/or the blowing wind velocity from the hot-air blowing nozzle are each set within a desired range. In Patent Document 1, the drying process is divided into an early drying stage, an intermediate drying stage, and a latter drying stage, and the remaining amount of the solvent in the coating film is set within an appropriate range in each stage, especially the atmosphere temperature and the blowing wind velocity from the nozzle during the intermediate drying stage are set within appropriate ranges.

The reasons for dividing the drying process into the early drying stage, the intermediate drying stage and the latter drying stage are as follows. For example, considering a drying case in which a coating film for forming an active material layer coated on a substrate sheet is dried in a drying device while traveling the substrate sheet, the preferable relation between the atmosphere temperature (the temperature of the coating film) in the drying device and the drying time (stay time [traveling time] in the drying device) is, normally, shown in FIG. 1. That is, at the early drying stage, it becomes a region in which the temperature rises relatively rapidly. At the intermediate drying stage, it becomes a temperature region in which the temperature is kept almost constant or rises moderately. At the latter drying stage, it becomes a region in which the temperature rises again relatively rapidly to reach a predetermined maximum temperature. In order to avoid becoming the drying state as mentioned above in which the bonding agents are unevenly distributed in the coating film in the thickness direction thereof, it is known that it is especially necessary to keep a temperature region in which the temperature is kept almost constant or rises moderately like in the intermediate drying stage shown in FIG. 1 for a predetermined period of time or more. Among other things, in order to obtain a coating film in a desired drying state with no unevenly distributed bonding agents, it is said that it is most important to keep the temperature region A for a predetermined period of time and set the timing B of changing from the intermediate drying stage to the latter drying stage to an appropriate timing (i.e., set the timing to be not too early and not too late). When the timing B is too early, the drying time required at the intermediate drying stage cannot be secured. When the timing B is too late, the drying excessively progresses at the intermediate drying stage, the entire drying process becomes unnecessarily long, or the entire length of the drying device becomes unnecessarily long. Further, at the early drying stage, it is possible to increase the temperature relatively rapidly. However, when the rate of temperature increase is too fast, the temperature at the time of entering into the intermediate drying stage tends to exceed the temperature acceptable range required at the intermediate drying stage. This prevents starting of the intermediate drying stage at a temperature within a predetermined acceptable range, which makes it difficult to obtain an appropriate coating film drying state. To the contrary, when the rate of temperature increase is too slow, the time until starting the intermediate drying stage becomes too long, or the length of the drying device required for the early drying stage becomes too long. In either case, it is not preferable in view of production efficiency. Similarly at the latter drying stage, it is possible to raise the temperature relatively rapidly. However, when the rate of temperature increase is too fast, the temperature tends to exceed a temperature acceptable range of a final set temperature, which finally makes it difficult to obtain an appropriate coating film drying state. To the contrary, when the rate of temperature increase is too slow, the entire drying process becomes too long, or the entire length of the drying device becomes too long. This is also not preferable in view of production efficiency. Observing the entire drying process, especially, the temperature and the drying time required at the intermediate drying stage are narrow in acceptable range (so-called process window) with respect to condition changes. In other words, at the intermediate drying stage, predetermined almost constant drying temperature and drying time are required, which allows less room for changing the conditions. Therefore, in order to perform an efficient production as a whole, or to perform desired drying within a minimum required drying process time (the entire length of the drying device), as for the condition at the intermediate drying stage, it is considered to be the most important factor that, while maintaining a predetermined condition, the transition from the early drying stage to the intermediate drying stage is performed appropriately and quickly, and the transition from the intermediate drying stage to the latter drying stage is performed at an appropriate timing.

It can be said that setting the drying conditions as described in the aforementioned Patent Document 1 is a reasonable method as a method of drying a coating film by a desired drying progress property while avoiding defects as mentioned above. The method described in this Patent Document 1, however, is a method in which, basically, each target range of the solvent remaining amount at the early drying stage, the intermediate drying stage, and the latter drying stage is preliminarily determined as premises, and each drying condition is set so as to fall within each range. This is a method that merely sets the condition. Therefore, in order to decide the optimum set condition, it is essentially required to actually find out the optimum condition range by preliminarily performing a test, etc. In cases where the optimum condition range never fluctuates at all, when the optimum condition range is actually once found by a test, etc., based on that, it is sufficient to set the optimum condition every time. In reality, however, the optimum drying condition range fluctuates depending on seasons, the difference of production type, etc. For this reason, in reality, regardless that the drying condition considered to be optimum in each zone of the drying device has been set, the actual state is as follows. The drying state of the coating film is visually judged by looking through the inspection window provided at each zone of the drying device (actually, the color, etc., of the surface of the coating film is visually judged). When it is judged that it is in a desired drying state, the operation is continued with the set condition as it is. When it is judged that it deviates from a desired drying state, the operation is performed by changing the set condition so as to become a desired drying state. Therefore, there is a possibility that the quality of the product to be produced becomes unstable and fluctuates. If the timing of changing the set condition based on the visual inspection is missed, there is a possibility of causing a large loss.

### SUMMARY

The object of the present invention is, in view of the aforementioned situation, to provide a production device of an electrode plate capable of grasping an actual drying state of a coating film actually in real time so that a desired drying progress state can be always maintained along an entire region of a drying device.

In order to solve the aforementioned problems, an electrode plate production device according to the present invention comprises a drying device for progressing drying of a coating film for forming an active material layer containing at least an active material, a bonding agent and a solvent coated on a surface of a substrate sheet for forming a current collector while traveling the substrate sheet. A plurality of surface state detection means capable of detecting a surface state of the coating film in a noncontact manner are provided in the drying device in a traveling direction of the substrate sheet.

In such an electrode plate production device according to the present invention, the surface state of the coating film corresponding to the drying state of the coating film on the substrate sheet traveling in the drying device is actually detected by noncontact surface state detection means, and a plurality of the surface state detection means are arranged in the traveling direction of the substrate sheet. Therefore, it can be actually and essentially detected in real time how the drying of the coating film is being progressed according to the traveling of the substrate sheet. Therefore, the actual drying state can be recognized correctly and assuredly as detected information. By setting or controlling the drying condition based on that, it becomes possible to easily set or control an optimum drying condition at that time. As a result, even if the optimum drying condition range is changed due to seasons or difference of the production type, it becomes possible to always and assuredly maintain the optimum drying condition which can be fed back from the actual dry result, which enables always performing optimum drying.

In the electrode plate production device according to the present invention, as a surface state detection means detectable of a surface state of the coating film in a noncontact manner, for example, any one of a sensor capable of detecting a surface temperature of the coating film (noncontact temperature sensor), a sensor capable of detecting surface gloss or brightness of the coating film (noncontact gloss or brightness sensor), a sensor capable of detecting reflected light from a surface of the coating film (for example, a reflection sensor of a laser beam, etc.), a noncontact moisture meter capable of detecting moisture contained in the coating film by measuring infrared energy emitted from the surface of the coating film, and image processing means capable of photographing an image of the surface of the coating film to determine quantity of the surface state from a photographed image (for example, a means in which a CCD camera and an image processing device are combined). As the aforementioned noncontact moisture meter, for example, a meter for measuring infrared energy of a specific wavelength which is easily absorbed by moisture can be exemplified. Among other things, it is more preferable to use a meter configured to measure infrared energy of a wave length (reference wavelength) which is hardly absorbed by moisture in addition to the aforementioned wavelength to calculate the moisture content (content or density of moisture) from a ratio to the infrared energy of the specific wavelength.

In the above, the drying progress state of the coating film and the surface temperature change property of the coating film are closely related, and preferred drying of the coating film can be performed by realizing the coating film surface temperature change property as shown in the aforementioned FIG. 1. Among other things, by setting the condition at the start of the intermediate drying stage, the condition at the time of the finish, and the drying time from the start to the finish to the desired conditions as shown in FIG. 1, the bonding agents are not distributed unevenly, which makes it easy to obtain a coating film of a desired drying state. Further, the drying progress state of the coating film is also closely related to the surface gloss or brightness of the coating film, or the change property of the reflected light from the surface of the coating film. By detecting these property changes, it also becomes possible to recognize the actual drying progress state of the coating film as real time detected information. Among other things, as to the uneven distribution of the bonding agents at the intermediate drying stage, when the bonding agents are unevenly distributed on the surface side of the coating film, the surface gloss or brightness of the coating film, or the reflected light from the surface of the coating film changes. Therefore, by detecting the property changes, it becomes possible to recognize whether or not the drying is appropriately progressing. Similarly, by an image processing means, the actual drying progress state of the coating film can be detected and recognized. Further, in cases where a noncontact moisture meter for measuring infrared energy emitted from the surface of the coating film is used, it has been confirmed by an off-line test that the moisture content change property of the coating film and the coating film surface temperature change property as shown in FIG. 1 (therefore, the drying progress state of the coating film) are closely related as shown in, for example, FIG. 2. Therefore, by satisfying the moisture content a, b, c, d, and e at each timing in FIG. 2, it becomes possible to set a desired drying condition similar to that shown in FIG. 1. In other words, by detecting the content rates by a plurality of noncontact moisture content meters, the actual drying progress state of the coating film can be detected/recognized.

A plurality of such surface state detection means can be arranged in the width direction of the substrate sheet. By arranging a plurality of surface state detection means also in the width direction of the substrate sheet, it becomes possible to detect the variation of the drying states in the width direction of the substrate sheet as well as the drying progress state in the traveling direction of the aforementioned substrate sheet, which in turn makes it possible to always perform desired drying along the entire width.

Further, the present invention can be applied to both the single-sided coating and the double-sided coating. In detail, it can be configured such that a coating film before drying is coated on one side of the substrate sheet and the surface state detection means is provided at the coating film side of the substrate sheet. Further, it also can be configured such that a coating film before drying is coated on both sides of the substrate sheet and the surface state detection means are provided at both sides of the substrate sheet. Further, as to the traveling form of the substrate sheet in the drying device, it can be configured such that the sheet travels in the air in a noncontact state. For example, in the case of a single-sided coating, as will be shown in the following embodiment, it can be configured such that supporting/transferring rollers are provided at the lower surface side to support the lower surface side of the substrate sheet in a contact manner.

Further, in the electrode plate production device according to the present invention, it is preferable that the drying device is provided with a plurality of drying condition control means capable of individually controlling a condition of drying the coating film at least in a traveling direction of the substrate sheet (for example, every desired zone to be individually controlled). Providing a plurality of drying condition control means enables control of the drying condition with a high degree of accuracy every zone in the drying device. Therefore, the drying progress state of the coating film in the driving direction of the substrate sheet can be controlled in a more preferable state.

Further, in the present invention, it is preferable that the production device further includes means for storing or setting a preliminarily grasped target dry progress property of the coating film in a traveling direction of the substrate sheet in the drying device, and the drying condition control means is configured to be controllable of the condition of drying the coating film by referring to a difference between the target dry progress property and a detected state by the surface state detection means. By configuring as mentioned above, the target drying state, especially drying progress state, can be realized more assuredly. The target drying progress property is obtained in advance by a test, etc., as a surface state change property of the coating film.

Further, it can be configured such that the drying condition control means is provided so as to be individually controllable with respect to both surface sides of the substrate sheet. Such individually controlling both surfaces is effective, especially when coating the aforementioned coating film on both surfaces of the substrate sheet, and it becomes possible to dry each surface of the coating film under an optimum condition. However, in the case of individually controlling both surfaces as mentioned above, even in the case of coating one surface, the drying condition near the coating film surface side and the drying condition near the substrate sheet side of the coating film can be controlled more minutely. Therefore, especially in cases where it is required to control the drying condition with a high degree of accuracy, it is effectively applicable.

Further, in the electrode production device according to the present invention, although the traveling form of the substrate sheet in the air in a noncontact state in the drying device is not specifically limited, considering that the drying device in the form of an oven is relatively long in the traveling direction of the substrate sheet, it is preferable that the substrate sheet is traveling in an air floating state. For example, it can be configured such that air blowing nozzles for holding the substrate sheet in an air floating state are arranged above and below the traveling path of the substrate sheet in the drying device in the traveling direction of the substrate sheet.

At this time, since the substrate sheet is not rigid but flexible, the substrate sheet traveling while being supported in an air floating state tends to undulate up and down in a wavy manner in the traveling direction. Therefore, to realize a stable traveling on the premise of such easy-to-undulate property, for example, it is possible to employ a structure in which the upper side air blowing nozzle and the lower side air blowing nozzle are arranged in a zigzag manner in the traveling direction of the substrate sheet. By structuring as mentioned above, the air blowing opening of the upper side air blowing nozzle and the air blowing opening of the lower side air blowing nozzle are arranged alternately in the traveling direction of the substrate sheet. The substrate sheet undulates downward at the position corresponding to the air blowing opening of the upper side air blowing nozzle and upward at the position corresponding to the air blowing opening of the lower side air blowing nozzle. However, the wavy state is intentionally formed and is kept in a stable wary shape corresponding to the position of each air blowing opening, and therefore it becomes possible to maintain the stable noncontact air traveling of the substrate sheet in the drying device.

In the case of the drying device using the air blowing nozzle as mentioned above, it is preferable that a temperature or a wind velocity of the blowing air from the air blowing nozzle, or both of them, are configured to be controllable individually every air blowing nozzle or every zone of the drying device in the traveling direction of the substrate sheet. By structuring as mentioned above, depending on the target drying progress property of the coating film, it becomes possible to control the drying condition more minutely, which in turn can realize more preferable drying.

As mentioned above, according to the electrode plate production device according to the present invention, in drying the coating film on the substrate sheet traveling in the drying device in a noncontact state, the actual drying progress state of the coating film can be detected as the surface state of the coating film corresponding to the drying state accurately and assuredly in essentially real time by the noncontact surface state detection means. Therefore, based on the detected result, it becomes possible to perform drying of the coating film always with a desired drying progress property. As a result, an electrode plate of a desired quality can be stably produced without generating product losses.

### BRIEF DESCRIPTION OF THE DRAWINGS

FIG. 1 is a characteristic diagram showing a preferred relation between a temperature of a coating film and a drying time in a drying device.

FIG. 2 is a characteristic diagram showing a relation between the drying progress property shown in FIG. 1 and a moisture content change property of the coating film.

FIG. 3 is a schematic cross-sectional view of an electrode plate forming material showing a state before drying the coating film.

FIG. 4 is a schematic structural view showing a principle part of the production device of an electrode plate according to one embodiment of the present invention.

FIG. 5 is a partial schematic longitudinal cross-sectional view of the drying device empathetically exemplifying an air floating state by upper and lower air blowing nozzles in the device shown in FIG. 4.

FIG. 6 is a partial plan view of a substrate sheet showing an example of a case in which a plurality of surface state detection means are provided in a widthwise direction.

FIG. 7 is a schematic structural view showing a principle part of a production device of an electrode plate according to another embodiment of the present invention.

FIG. 8 is a schematic structural view showing a principle part of a production device of an electrode plate according to still another embodiment of the present invention.

### DETAILED DESCRIPTION OF EMBODIMENTS

Hereinafter, embodiments of the present invention will be explained with reference to the drawings.

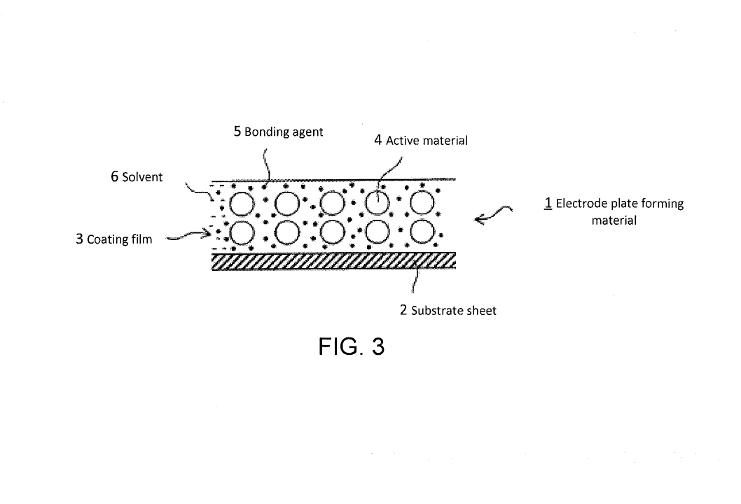

Initially, about a state before drying a coating film to be dried in the present invention, an example of its cross-section is exemplified in FIG. 3. In FIG. 3, “1” denotes an electrode plate forming material. The electrode plate forming material 1 includes a substrate sheet 2 for forming a current collector made of an aluminum foil, a copper foil, etc., which is flexible and unstable in dimension, and a coating film 3 for forming an active material layer coated on one surface or both surfaces (one surface in the illustrated example) of the substrate sheet 2. The coating film 3 contains at least a granular active material 4, a granular bonding agent 5 smaller than the granular active material, and a solvent 6 for keeping them in a slurry state at the time of coating. By drying, most of the solvent 6 will be evaporated, and the active materials 4 are fixed with each other by the bonding agents 5 existing around the active materials 4, and the active material layer is bonded to the substrate sheet 2. Thus, a sheet-like electrode plate forming material 1 is continuously produced. This sheet-like electrode plate forming material 1 is cut depending on a size of an electrode plate actually used, and used to produce a lithium-ion battery, a fuel cell, etc.

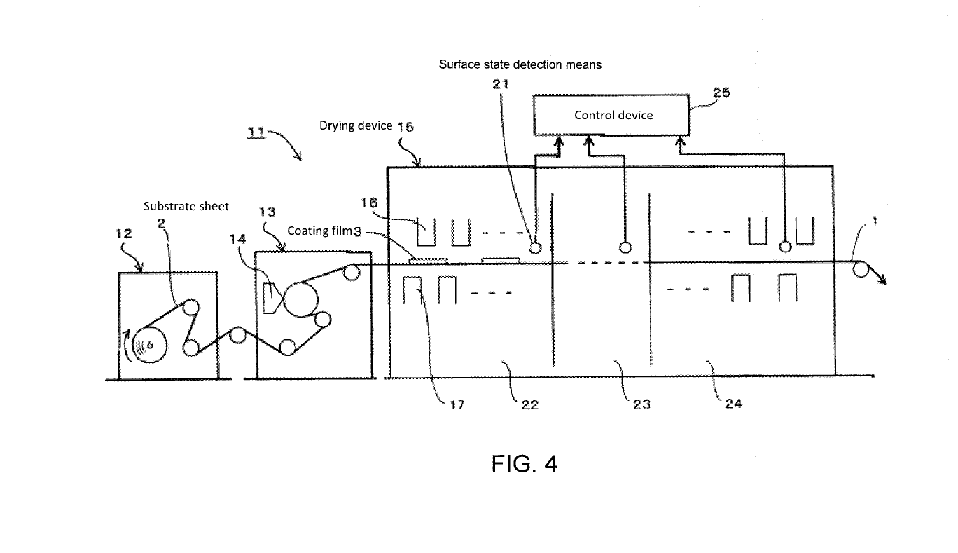

The electrode plate forming material 1 as mentioned above is produced by, for example, an electrode plate production device as shown in FIG. 4. In the electrode plate production device 11 shown in FIG. 4, the substrate sheet 2 is rewound from a roll-like wound sheet with a rewinding machine 12, and a coating film 3 as shown in FIG. 3 is coated on the surface of the substrate sheet 2 through a coating nozzle 14 in a coater 13. The substrate sheet 2 on which a coating film 3 is coated is fed to a hot-air oven type drying device 15, and drying of the coating film 3 by hot-air of a predetermined temperature blown from the upper and lower blowing nozzles 16 and 17 is performed in the drying device 15. Although FIG. 4 illustrates coating films 3 intermittently coated in the traveling direction of the substrate sheet, it can be configured to form a continuous coating film. The electrode plate forming material 1 that the drying of the coating film 3 was completed in the drying device 15 is subjected to measurements of a thickness, etc., of the coating film after drying as needed, and then wound with a winding machine (not illustrated). In cases where performing coating and drying of the coating film 3 every each surface, the wound roll-shaped sheet is again mounted on the rewinding machine 12 with the upper and lower surfaces of the substrate sheet 2 to be rewound set upside down and the aforementioned process is repeated.

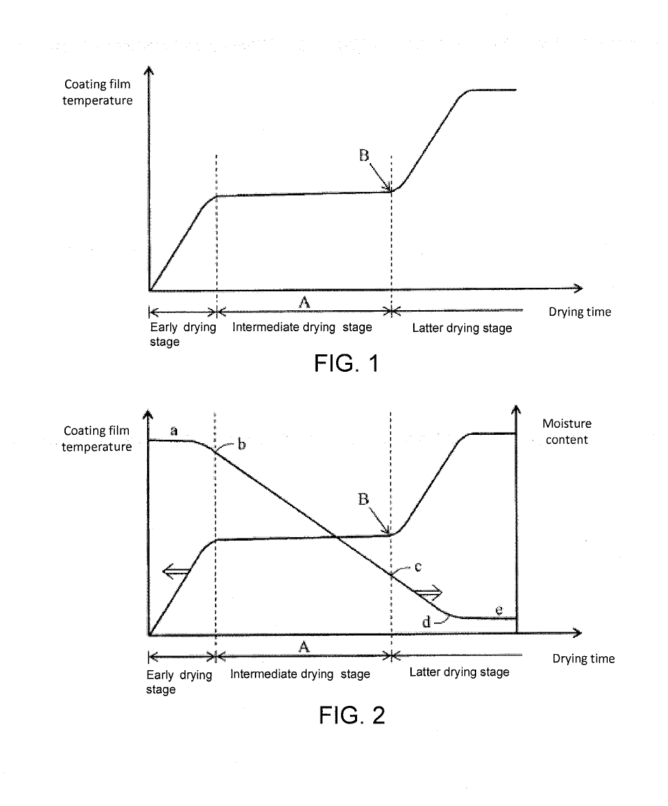

In the present invention, in the drying device 15, a plurality of surface state detection means 21 capable of detecting the surface state of the coating film 3 in a noncontact manner are provided on a coating side of the coating film 3 of the substrate sheet 2 in the traveling direction of the substrate sheet 2. In the schematic structure of the drying device 15 shown in FIG. 4, the drying device 15 is partitioned, from its inlet side, into zones 22, 23 and 24 for the early drying stage, the intermediate drying stage and the latter drying stage shown in FIGS. 1 and 2. Each of the zones 22, 23 and 24 for the early drying stage, the intermediate drying stage and the latter drying stage can be further partitioned into a plurality of small zones. In the illustrated example, at the vicinity of the end of each zone 22, 23 and 24 for the early drying stage, the intermediate drying stage and the latter drying stage as seen in the traveling direction of the substrate sheet 2, a surface state detection means 21 is arranged so that the surface state of the coating film 3 at the end of the early drying stage and/or the coating film 3 at the beginning of the intermediate drying stage, the surface state of the coating film 3 at the end of the intermediate drying stage and/or the coating film 3 at the beginning of the latter drying stage, and the surface state of the coating film 3 at the end of the latter drying stage can be detected. However, the arrangement of the surface state detection means 21 is not limited to the example shown in FIG. 4 so long as detected information which is necessary to realize the preferred drying progress property as shown FIGS. 1 and 2 can be obtained. Further, a more number of surface state detection means 21 can be arranged in the traveling direction of the substrate sheet 2.

The detected information by each surface state detection means 21 is forwarded to a control device 25. The control device 25 is configured to judge whether or not the drying state of the coating film 3 at the position of each surface state detection means 21 is within a target range. For example, when the surface state detection means 21 is a noncontact temperature sensor capable of detecting the surface temperature of the coating film 3, at the control device 25, it is judged whether or not the detected information (detected temperature) from each temperature sensor is within the, target range (for example, it is judged whether or not the detected information is within an allowable range of the temperature property as shown in FIG. 1). Further, the control device 25 is configured to output a control signal depending on the judgment, such as a control signal of the temperature of the hot-air to be blown through the air nozzles 16 and 17 in each zone 22, 23 and 24 (as needed, a control signal also including a blowing wind velocity), or a control signal of the temperature of the hot-air to be blown through each of the air nozzles 16 and 17 (as needed, a control signal also including a blowing wind velocity). Based on this output, the temperature of each zone 22, 23 and 24 or the temperature of each air blowing nozzle 16 and 17 are controlled (or, in addition to the temperature control, a blowing wind velocity control is performed). With this control, it becomes possible to control the temperature of the coating film 3 to the temperature property as shown in FIG. 1. By this temperature control of the coating film 3, the drying progress of the coating film 3 in the drying device 15 is controlled to the desired drying progress property as shown in FIGS. 1 and 2.

Even when, as the surface state detection means 21, other than the temperature sensor, a noncontact gloss or brightness sensor capable of detecting the surface gloss or brightness of the coating film as mentioned above, a sensor capable of detecting the reflected light from the surface of the coating film, a noncontact moisture meter capable of detecting the moisture contained in the coating film by measuring the infrared energy emitted from the surface of the coating film, or an image processing means capable of photographing an image of the surface of the coating film to determine the quantity of the surface state from the photographed image, is employed, by merely preliminarily grasping the desired change property such as the surface gloss, the brightness, the reflected light, the moisture content, or the coating film surface image corresponding to the desired drying progress property, it becomes possible to control the actual coating film drying progress state to a desired drying progress property by comparing the desired change property and the actual detected information and controlling the temperature in each zone 22, 23 and 24 or the temperature of each flowing nozzle 16 and 17 based on the comparison in the same manner as mentioned above (or, by controlling the blowing wind velocity in addition to the temperature control). When the coating film 3 is dried with the desired drying progress property, the bonding agents 5 are evenly distributed in the coating film 3, which enables to obtain an electrode plate material 1 of a desired finish state in which the coating film 3 is strongly fixed to the substrate sheet 2. Thus, an electrode plate having a desired property can be produced from the electrode plate forming material 1. It is possible to obtain the aforementioned change property in advance by an off-line test.

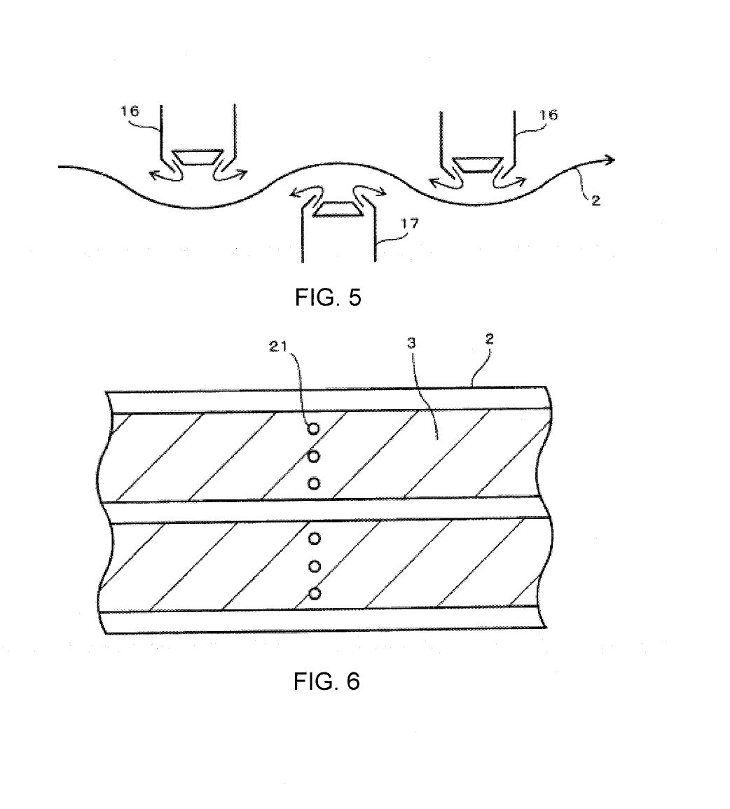

In the aforementioned drying device 15, it is possible to employ the configuration in which the upper and lower blowing nozzles 16 and 17 are arranged in a zigzag manner (alternatively) in the traveling direction of the substrate sheet 2 as shown in, for example, FIG. 5. Although the substrate sheet 2 itself is a thin sheet-like member and therefore tends to undulate at the time of the traveling in an air floating state, the alternative arrangement of the upper and lower air blowing nozzles 16 and 17 causes a forcible traveling in a wavy state as emphatically shown in FIG. 5. Since the wavy state is stably maintained, the undulation of the substrate sheet 2 is suppressed, realizing a stable traveling. As to the air blowing wind velocities of the upper and lower nozzles 16 and 17, it is possible to control so that the wind velocities differ from each other to realize a stable traveling of the substrate sheet 2 while considering the own weight, etc., of the traveling substrate sheet 2. When drying of the coating film 3 is performed in a one side coated state as exemplified in FIG. 4, it can be controlled such that the temperature of the blowing air from the upper air blowing nozzle 16 which directly contributes to the drying of the coating film 3 and the temperature of the blowing air from the lower air blowing air nozzle 17 which indirectly contributes to the drying of the coating film 3 via the substrate sheet 2 from a rear side differ from each other. Further, when drying is performed in a state in which both surfaces of the substrate sheet 2 are coated with coating films 3, it is possible to employ a control configuration in which, for example, the temperatures of the blowing airs from the upper and lower blowing nozzles 16 and 17 are controlled to be the same temperature and only the air blowing wind velocities are controlled to be different from each other in view of the traveling stability of the substrates sheet 2.

Further, as shown in FIG. 6, a plurality of surface state detection means 21 can be arranged in the widthwise direction of the substrate sheet 2. Such widthwise plural arrangement structure of the surface state detection means 21 is, especially when the coating width of the coating film 3 is large or when coating films 3 are coated in plural lines, effective so as to fall the variation range within an allowable range since it is expected that the drying state of the coating film 3 differs in the width direction. Further, when the upper and lower air blowing nozzles 16 and 17 are configured such that the air blowing temperature and/or the blowing wind velocity are changeable in the nozzle longitudinal direction (coating film width direction), by feeding back the detected information from the plurality of surface state detection means 21 arranged in the width direction, it becomes possible to control with a higher degree of accuracy so that the drying state of the coating film 3 becomes a desired state in which the drying state of the coating film 3 is even in the width direction.

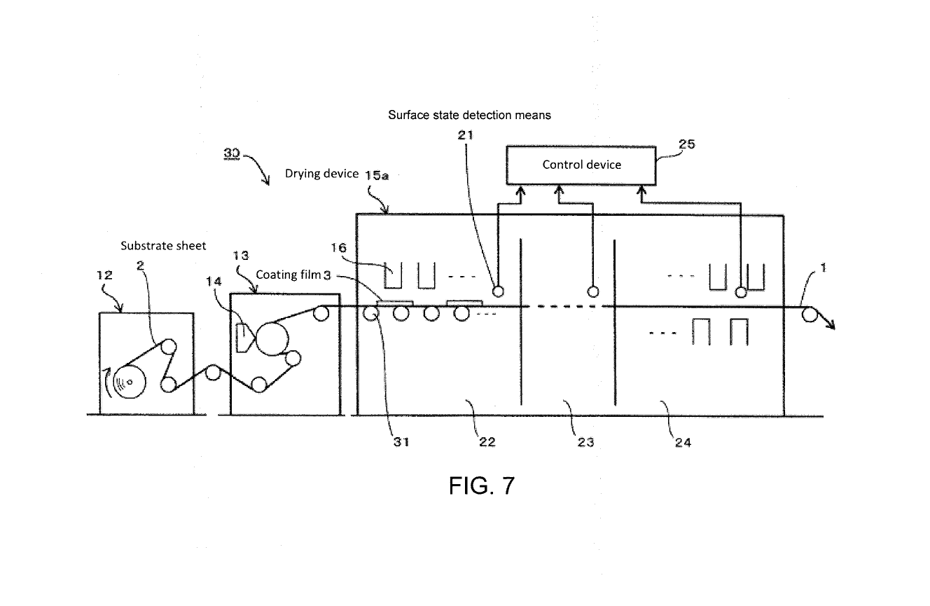

FIG. 7 illustrates an electrode plate production device 30 according to another embodiment of the present invention. In this embodiment, for example, as seen in the traveling direction of the substrate sheet 2, at the zone 22 for the early drying stage in the drying device 15a (in some cases, further including the downstream side zone), the lower surface side of the substrate sheet 2 (the surface side on which no coating film 3 is coated) is supported by supporting/transferring rollers 31 arranged in plural. At the upper surface side of the substrate sheet 2, it is configured such that the coating film 3 is dried by the flowing air from the upper side air blowing nozzle 16 in the same manner as mentioned above. The other structures are essentially the same as those of the structure shown in FIG. 4, and therefore the explanation will be omitted by allotting the same reference symbol of FIG. 4 to the same member shown in FIG. 4.

Such a configuration is effective for the case in which, for example, a large amount of heat quantity should not be given to the coating film 3 at the early drying stage, etc. The concrete method of decreasing the heat quantity is to decrease the blowing wind velocity from the air blowing nozzle 16. However, since the substrate sheet 2 itself is supported by the supporting/transferring rollers 31 even the wind velocity is decreased, the high traveling stability can be maintained.

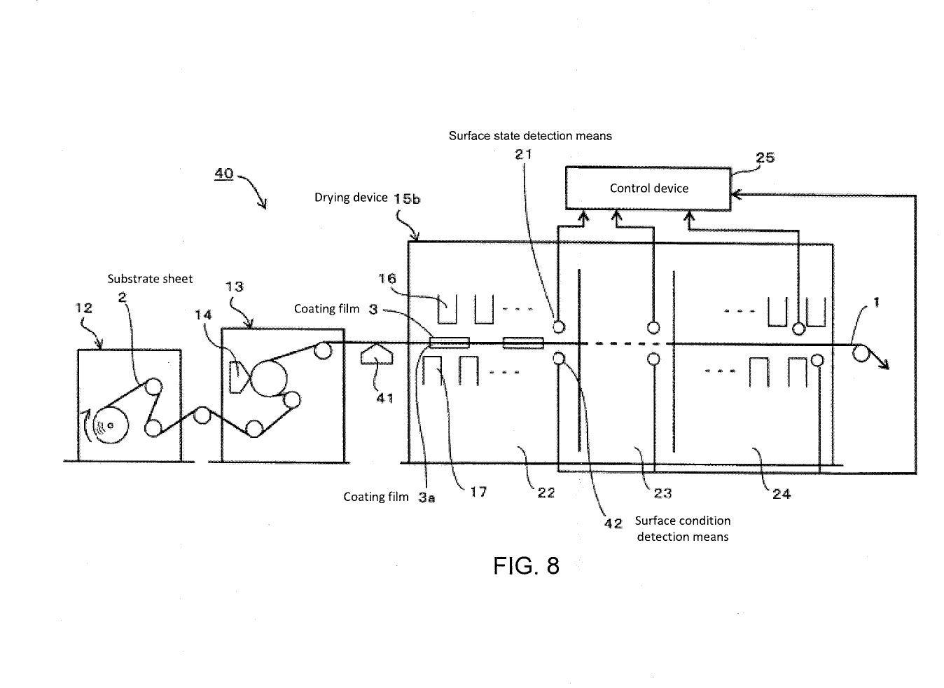

FIG. 8 shows an electrode plate production device 40 according to still another embodiment of the present invention showing an example of both surface coating. In this embodiment, different from the device shown in FIG. 4, a coating film 3a is also coated on the lower surface side of the substrate sheet 2 by the coating nozzle 41 before the drying device 15b, and the substrate sheet 2 is introduced in the drying device 15b in a both surface coated state. The upper and lower air blowing nozzles 16 and 17 are arranged in the same manner as shown in FIG. 4, and the substrate sheet 2 is traveled in the air-floating state. In the drying device 15b, the drying state of the coating film 3 coated on the upper surface side of the substrate sheet 2 is detected by the surface state detection means 21 in the same manner as shown in FIG. 4. Further in this embodiment, the drying state of the coating film 3a coated on the lower surface of the substrate sheet 2 is detected by the surface state detection means 42 arranged below the substrate sheet 2. The other structures are essentially the same as those of the structure shown in FIG. 4, and therefore the explanation will be omitted by allotting the same reference symbol of FIG. 4 to the same member shown in FIG. 4.

In such embodiment, drying is progressed so that the drying state of the coating film 3 coated on the upper surface side to be detected by the surface state detection means 21 and the drying state of the coating film 3a coated on the lower surface side to be detected by the surface state detection means 42 become equal, which enables the equalization (homogenization) of the dry quality of both the upper and lower coating films. Thus, a double-side coated type electrode plate of a desired quality can be obtained.

As mentioned above, the present invention can be applied to both one-side coating and double-side coating. In the case of coating one surface, since the aforementioned air floating type and the roll supporting type can be freely selected, the selection range of the heat quantity to be given in the drying device as a whole covers a wide range. For example, the blow wind velocity range from the air blowing nozzle 16 can be selected from the range of 3 to 20 m/sec and the temperature range can be selected from the range of 60 to 180° C. On the other hand, in the case of simultaneously coating both surfaces, since it is a state in which the coating films are coated on both surfaces of the substrate sheet 2 in the drying device, only the air floating type can be selected. Further, since it is a state in which the coating films are coated on both surfaces of the substrate sheet 2, the weight of the electrode plate forming material traveling in the drying device is heavier as compared with the one surface side coating case, and therefore the blowing wind velocity from the air blowing nozzle 17 toward the lower surface side should be increased to float the electrode plate forming material by the air floating method. Specifically, for example, it can be exemplified that the blowing wind velocity range is 8 to 30 m/sec and the temperature range is 60 to 180° C. Furthermore, in order to stabilize the traveling path of the electrode plate forming material in the drying device, for example, it is required to employ a measure for increasing the blowing wind velocity toward the lower surface side than the blowing wind velocity toward the upper surface side. In this case, however, a difference in heat quantity is generated between the upper and lower surface sides. As a result, there is a possibility of causing a defect that the dry quality differs between the coating films of the upper and lower surface sides.

As a measure to prevent generation of such defect, for example, when drying of the lower side is progressed quicker than that of the upper side, the following measures can be employed to equalizing (homogenizing) the dry quality of the upper and lower surface sides.

(1) The temperature of the blowing hot air toward the lower surface side and the temperature of the blowing hot air toward the upper surface side are differentiated. For example, depending on the value of the surface state detection means for detecting the drying state, the temperature of the blowing hot air toward the lower surface side is decreased by 5 to 40° C.

(2) The wind velocity of the blowing hot air toward the lower surface side is decreased. Specifically, the wind velocity or direction of the blowing hot air from the air nozzle is adjusted. For example, using a nozzle equipped with blowing openings different in blowing direction in a single nozzle, the blowing direction is changed without changing the floating force of the substrate sheet so that the air flow becomes a parallel flow, a diffusion flow, or a collective flow to change the direction and wind velocity of the air blowing. By doing so, while keeping the distance between the air blowing nozzle and the substrate sheet constant, the wind velocity of the blowing air can be reduced, the heat quantity of the hot air can be reduced, and the drying of the lower surface side can be delayed.

As explained above, by the aforementioned measures (1) and (2), since the drying states of the upper and lower surfaces of the electrode plate forming material in which coating films are coated on both surfaces of the substrate sheet 2 can be individually adjusted, the dry quality of the coating film of the upper and lower surfaces can be equalized.

Furthermore, as another method,

(3) an auxiliary heater can be provided at the upper surface side. As an auxiliary heater, an infrared heater or an induction heating heater can be used. By providing such an auxiliary heater between the upper surface side air blowing nozzles, without giving unnecessary wind velocity to the upper surface side (without giving an unnecessary force on the upper surface), a desired additional heat quantity can be given. As the temperature range of the auxiliary heater, for example, in cases where the solvent of the coating film is a solvent system, the range can be arbitrarily selected from the range of 80 to 200° C. In cases where the solvent is an aqueous system, the range can be arbitrarily selected from the range of 60 to 800° C. As the heat source in the case of an infrared heater, other than an electrical type, a vapor type or a thermal oil type can also be selectable.

As a still another method,

(4) the gas concentration of the blowing hot air toward the upper and lower surface sides can be changed. In cases where the drying device is a hot air circulation type (a type in which not all of the blowing air is discharged, but a certain rate thereof is circulated again to exchange heat and then discharged), the solvent evaporated from the coating film is contained in the air, and the solvent is circulated and blown out through the air blowing nozzle together with the air. Therefore, by differentiating the concentration of the solvent in the blowing hot air at the upper surface side and the lower surface side, for example, 5 to 50 ppm at the upper surface side and 500 to 1,500 ppm at the lower surface side, even in cases where the wind velocity at the lower surface side is lager, it becomes possible to control the drying at lower surface side to equalize the dry quality of the upper and lower surfaces of the coating film.

The production device of an electrode plate according to the present invention is applicable to various electrode plate productions in which a coating film is dried while traveling a substrate sheet in the air.

1. An electrode plate production device comprising:
a traveling device configured to travel a substrate sheet for forming a current collector in a traveling direction;
a coating device configured to coat a surface of the substrate sheet for forming the current collector with a coating film for forming an active material layer, with the coating film including at least an active material, a bonding agent and a solvent;
a drying device configured to dry the coating film for forming the active material layer on the surface of the substrate sheet for forming the current collector; and
a plurality of surface state detection devices configured to detect a surface state of the coating film in a noncontact manner, the surface state detection devices being arranged within the drying device in the traveling direction of the substrate sheet with respect to each other.

2. The electrode plate production device according to claim 1, wherein
each of the surface state detection devices includes one of a sensor that is configured to detect a surface temperature of a surface of the coating film, a sensor that is configured to detect at least one of a surface gloss and a surface brightness of the surface of the coating film, a sensor that is configured to detect reflected light from the surface of the coating film, a noncontact moisture meter that is configured to detect moisture contained in the coating film by measuring infrared energy emitted from the surface of the coating film, and an image processing device configured to photograph an image of the surface of the coating film to quantify the surface state based on the image.

3. The electrode plate production device according to claim 1, wherein
the substrate sheet is configured to travel through the drying device in a noncontact state with respect to the drying device.

4. The electrode plate production device according to claim 1, wherein
the surface state detection devices are further arranged in a width direction of the substrate sheet with respect to each other.

5. The electrode plate production device according to claim 1, wherein
the surface state detection devices are disposed on both surface sides of the substrate sheet such that the surface state detection devices are configured to detect the surface state of the coating film while the coating film is further coated on both surfaces of the substrate sheet.

6. The electrode plate production device according to claim 1, wherein
the drying device further includes a plurality of drying condition control devices, the drying condition control devices being configured to control drying conditions of the coating film respectively, and being arranged at least in the traveling direction of the substrate sheet with respect to each other.

7. The electrode plate production device according to claim 6, further comprising
a control device configured to provide a predetermined target dry progress property of the coating film in the traveling direction of the substrate sheet in the drying device,
the drying condition control devices being further configured to control the drying conditions of the coating film based on a difference between the target dry progress property and a detected state by the surface state detection devices.

8. The electrode plate production device according to claim 6, wherein
the drying condition control devices are disposed on both surface sides of the substrate sheet such that the drying condition control devices are configured to be independently operated.

9. The electrode plate production device according to claim 1, further comprising
a plurality of air blowing nozzles configured to hold the substrate sheet in an air floating state with respect to the drying device, the air blowing nozzles being disposed on an upper side and a lower side with respect to a traveling path of the substrate sheet in the drying device, respectively, and being arranged in the traveling direction of the substrate sheet with respect to each other.

10. The electrode plate production device according to claim 9, wherein
the air blowing nozzles are arranged such that one of the air blowing nozzles disposed on the upper side and different one of the air blowing nozzles disposed on the lower side are arranged in a zigzag manner with respect to the traveling direction of the substrate sheet.

11. The electrode plate production device according to claim 9, wherein
the air blowing nozzles are configured to control at least one of a temperature and a wind velocity of a blowing air from the air blowing nozzles, respectively, in one of an independent manner and a manner according to zones of the drying device defined in the traveling direction of the substrate sheet within the drying device.

12. The electrode plate production device according to claim 6, wherein
the drying device further includes an auxiliary heater, the auxiliary heater being configured to be independently operated by the drying condition control devices.
